(19) United States
(12) Patent Application Publication
(10) Pub. No.: US 2015/0074966 A1
(43) Pub. Date: Mar. 19, 2015

(54) Electro-Mechanical Pipe Fusion Machine

(71) Applicant: McElroy Manufacturing, Inc., Tulsa, OK (US)

(72) Inventors: David W. Porter, Tulsa, OK (US); Paul John Donaldson, Broken Arrow, OK (US); Justin W. Eskridge, Tulsa, OK (US); Kean C. Chin, Owasso, OK (US)

(73) Assignee: McElroy Manufacturing, Inc., Tulsa, OK (US)

(21) Appl. No.: 14/029,601

(22) Filed: Sep. 17, 2013

(51) Int. Cl. B29C 65/00

(52) U.S. Cl. CPC B29C 65/002
USPC 29/282

(57) ABSTRACT

An electro-mechanical machine for fusing small diameter polyolefin pipe includes a carriage and controls. The carriage has fixed and travelling jaws that grip a pipeline and a pipe stick and electrically driven screws that bring the jaws into and out of close proximity for performance of fusion process tasks. The controls include an electrical closed loop circuit that controls operation of the screws to transfer the travelling jaws to a base axial distance from the fixed jaws and an electrical load cell feedback circuit that controls operation of the screws to reciprocate the travelling jaws in relation to the base axial distance in response to feedback from the load cells so as to maintain a predetermined force between the pipes.

### BACKGROUND OF INVENTION

This invention relates generally to fusion of polyolefin pipes and more particularly concerns the machines used to perform the pipe fusion process.

Existing devices for butt fusion of ½″ to 2″ outer diameter polyolefin pipe are manually operated. As a result, from joint-to-joint and operator-to-operator, it is difficult to replicate with a high degree of consistency those conditions known to afford excellent joint quality. What consistency there is cannot be monitored because manually operated devices do not provide data that can be used to assess and record the quality of a fused joint. Hydraulics have thus far proven to be inadequate to the resolution of these small diameter pipe fusion issues. Furthermore, even manual devices require an electrical power source adequate to meet the energy demands of the fusion heaters. The need for hard wiring to a fusion heater limits the mobility of the manual devices.

It is, therefore, an object of this invention to provide a pipe fusion machine that is suitable for fusion of small diameter polyolefin pipes. It is also an object of this invention to provide a pipe fusion machine suitable for fusion of small diameter polyolefin pipes that is capable of providing data that can be used to assess and record the quality of a fused joint. A further object of this invention is to provide a pipe fusion machine suitable for fusion of small diameter polyolefin pipes that has unlimited mobility.

### SUMMARY OF INVENTION

In accordance with the invention a machine for fusing polyolefin pipe includes a carriage and controls.

The carriage has a base on which two screws are journaled for rotation in spaced-apart parallel horizontal alignment. Fixed jaws are provided at one end of the base. The lower fixed jaw is seated between the screws. The upper fixed jaw is pivotally mounted on the lower fixed jaw. The upper and lower fixed jaws are co-operable to grip and hold a pipeline centered on a longitudinal axis parallel to the screws. Travelling jaws are mounted for reciprocal travel on the screws. The lower travelling jaw is threaded on the screws. The upper travelling jaw is pivotally mounted on the lower travelling jaw. The upper and lower travelling jaws are co-operable to grip and hold a pipe stick centered on the same longitudinal axis as the pipeline. The screws are electrically driven to selectively reciprocate the travelling lower jaw toward and away from the fixed lower jaw to bring the gripped pipes into and out of close proximity, respectively, for performance of fusion process tasks.

The controls include an electrical closed loop circuit that controls operation of the screws to transfer the travelling lower jaw to a base axial distance from the fixed 1 owner jaw for performance of a fusion process task. The controls a lso include an electrical load cell feedback circuit that controls operation of the screws to reciprocate the travelling lower jaw in relation to the base axial distance in response to feedback from the load cells so as to maintain a predetermined force between the pipes during performance of the fusion process task.

### BRIEF DESCRIPTION OF THE DRAWINGS

Other objects and advantages of the invention will become apparent upon reading the following detailed description and upon reference to the drawings in which:

FIG. 1 is a perspective view perspective view of the carriage of an electro-mechanical fusion machine for small diameter polyolefin pipe;

FIG. 2 is a top plan view of the carriage of FIG. 1;

FIG. 3 is a cross sectional view taken along the line 3-3 of FIG. 2;

FIG. 4 is a cross sectional view taken along the line 4-4 of FIG. 2;

FIG. 5 is a block diagram of the electronics contained in the carriage of FIG. 1;

FIG. 6 is a block diagram of the electronics contained in the command module of the machine of FIG. 1;

FIG. 7 is a flow chart illustrating the operation of the user interface software of the machine of FIG. 1 for the collection of job and user data;

FIG. 8 is a flow chart illustrating the operation of the user interface software of the machine of FIG. 1 for the preparation of the machine for the facing phase of the fusion process;

FIG. 9 is a flow chart illustrating the operation of the user interface software of the machine of FIG. 1 for facing the pipes to be fused;

FIG. 10 is a flow chart illustrating the operation of the user interface software of the machine of FIG. 1 for the preparation of the machine for the heating phase of the fusion process;

FIG. 11 is a flow chart illustrating the operation of the user interface software of the machine of FIG. 1 for installation of the heater between the faces of the pipe to be fused;

FIG. 12 is a flow chart illustrating the operation of the user interface software of the machine of FIG. 1 for heating the faces of the pipes to be fused;

FIG. 13 is a flow chart illustrating the operation of the user interface software of the machine of FIG. 1 for the performance of the fusion phase of the process;

FIG. 14 is a sample of a joint report provided by the machine of FIG. 1; and

FIG. 15 is a perspective view of the carriage and command module of the is machine of FIG. 1 with a pipeline and a pipe stick gripped in the carriage fixed and travelling jaws.

While the invention will be described in connection with a preferred embodiment thereof, it will be understood that it is not intended to limit the invention to that embodiment or to the details of the construction or arrangement of parts illustrated in the accompanying drawings.

### DETAILED DESCRIPTION

An electro-mechanical machine for fusing polyolefin pipe includes a carriage 10 for performing the fusion tasks and controls for the operation of the carriage 10. The controls are in the carriage 10, a power base 100 and a command module 200.

### Carriage Structure

Turning to FIGS. 1-4, the carriage 10 includes a base 11 with upright left and right side portions 13 and 15. As shown, front and rear screws 17 and 19 are journaled in the upper ends of the side portions 13 and 15 for rotation about spaced-apart, horizontal, parallel axes 21 and 23.

A first approximately semi-circular lower jaw 25 is seated in the left side portion 13 between the screws 17 and 19 and a first approximately semi-circular upper jaw 27 is pivotally mounted on the rear of the upright left portion 13 for rotation into and out of closure on the lower jaw 25. When closed, the jaws 25 and 27 define a circular opening 29 of diameter equal to the outer diameter of the pipeline to be fused. The left side lower and upper jaws 25 and 27 are co-operable to firmly grip and maintain the pipeline in a position centered on a longitudinal axis 31 parallel to the screw axes 21 and 23.

A second approximately semi-circular lower jaw 35 is mounted for reciprocal travel on the screws 17 and 19 and a second approximately semi-circular upper jaw 37 is pivotally mounted on the rear portion of the lower jaw 35 for rotation into and out of closure on the lower jaw 35. When closed, the jaws 35 and 37 define a circular opening 39 of diameter equal to the outer diameter of the pipe stick to be fused. The screw-mounted lower and upper jaws 35 and 37 are co-operable to firmly grip and maintain a pipe stick in a position centered on the longitudinal axis 31.

An approximately semi-circular seat 41 is provided in the right side upright portion 15 between the screws 17 and 19. The seat 41 is also centered on the longitudinal axis 31 so that the pipe stick can extend from the travelling jaws 35 and 37 beyond the right side upright portion 15 of the base 11.

As best seen in FIGS. 2 and 3, the right end shafts 43 of the screws 17 and 19 are journaled through ball bearings 45, load cells 49 and thrust bearings 51 to pins 53. The left end shafts 55 of the screws 17 and 19 are journaled through bushings 57 to driven gears 59 mounted on the left end screw shafts 55. The mid-portions 61 and 63 of the screws 17 and 19 are threaded through first travelling jaw bushings 65 in sleeves 67, travelling jaw nuts 69 in the sleeves 67 and second travelling jaw bushings 71 in the lower travelling jaw 35. Thus, the torque from the driven gears 59 rotating the screws 17 and 19 is converted into an axial force applied to the travelling jaw 35. Rotation of the screws 17 and 19 in one direction causes the travelling jaw 35 to move closer to the fixed jaw 25 and in the other direction causes the travelling jaw 35 to move away from the fixed jaw 25 to bring gripped pipes into and out of close proximity for performance of fusion process tasks.

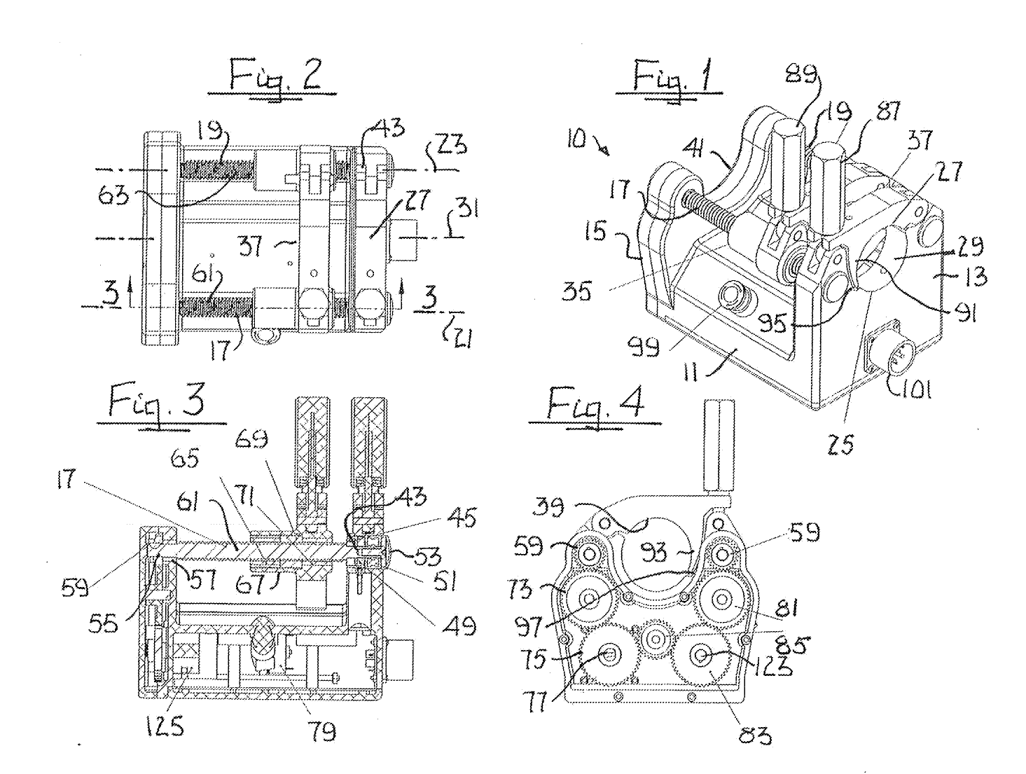

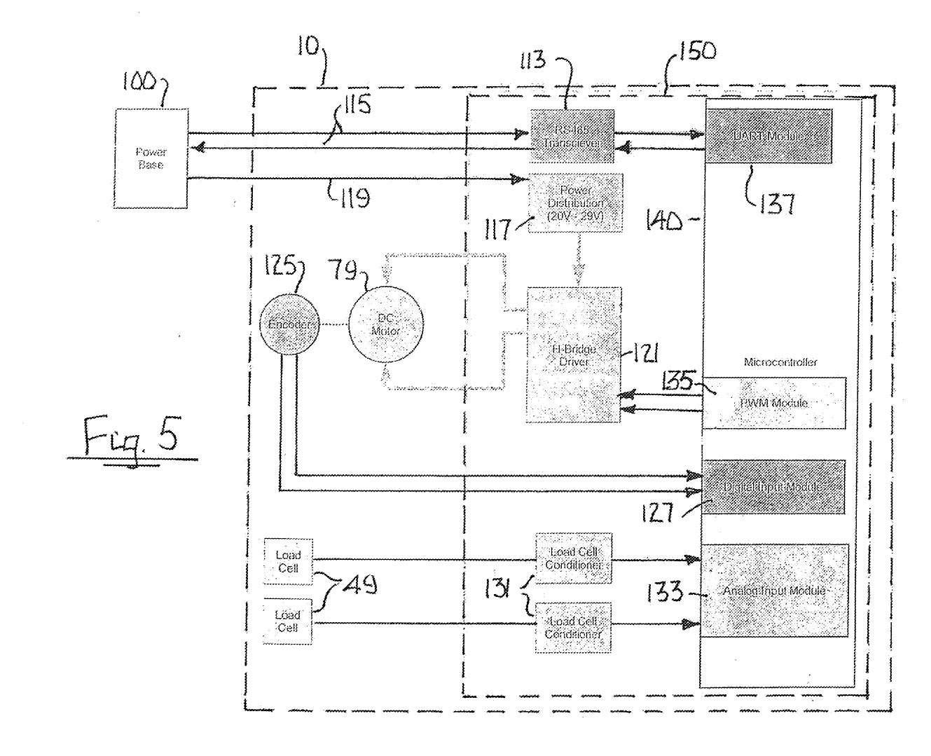

As best seen in FIG. 4, the forward driven gear 59 engages an idler gear 73 that engages a driving gear 75 on the shaft 77 of a dc motor 79. The rear driven gear 59 engages an idler gear 81 that engages an encoder coupling gear 83 that engages another idler gear 85 that is also engaged to the driving gear 75 on the shaft 77 of the dc motor 79. The encoder coupling gear 83 is mounted for rotation on the shaft 123 of a rotary encoder 125, as is seen in FIG. 5. Since there are an odd number of gears 73 or 81, 83 and 85 between the driving gear 75 and the driven gears 59, the screws 17 and 19 rotate in the same direction.

The upper jaws 27 and 37 have threaded clamp knobs 87 and 89 that engage the lower jaws 25 and 35 to draw the jaws 25 and 27 and 35 and 37 tightly against the pipeline and the pipe stick. As shown the upper jaws 27 and 37 also have downwardly depending curved tongues 91 and 93 which seat in mating grooves 95 and 97 in the lower jaws 25 and 35 to strengthen the mating relationship of the jaws. An emergency stop power button 99 is mounted on the front of the carriage 10 and a cable connector 101 is mounted on the right side of the carriage 10 for coupling the carriage 10 with the command module 200.

### Carriage Electrical System

Looking at the carriage block diagram of FIG. 5, the carriage power base 100 is in two way communication with a transceiver 113 via a communication bus 115 and with a power distribution module 117 via a power bus 119. An H-bridge driver 121 connected to the power distribution module 117 applies polar variable voltage to the dc motor 79 to move the traveling jaw 35 closer to or away from the fixed jaw 25. The shaft 123 of the rotary encoder 125 is coupled to the encoder coupling gear 83 which is in turn coupled to the shaft of the dc motor 79 by the idler gear 85 and the motor driving gear 75 as seen in FIG. 4. The rotary encoder 125 provides angular displacement feedback to a digital input module 127. Continuing to look at the carriage block diagram of FIG. 5, the outputs of the load cells 49 are fed through load cell conditioners 131 to an analog input module 133. A pulse width modulation module 135 provides the feedback signals to the H-bridge driver 121 to control the voltage applied to the dc motor 79. A universal asynchronous receiver/transmitter 137 is in two-way communication with the transceiver 113. The UART module 137, PWM module 135, digital input module 127 and analog input module 133 are part of the carriage microcontroller 140. The microcontroller 140, the transceiver 113, the power distribution module 117 the H-bridge driver 121 and the load cell conditioners 131 and 133 are on the carriage circuit board 150. The circuit board 150 is mounted in the carriage base 11.

### Command Module Electrical System

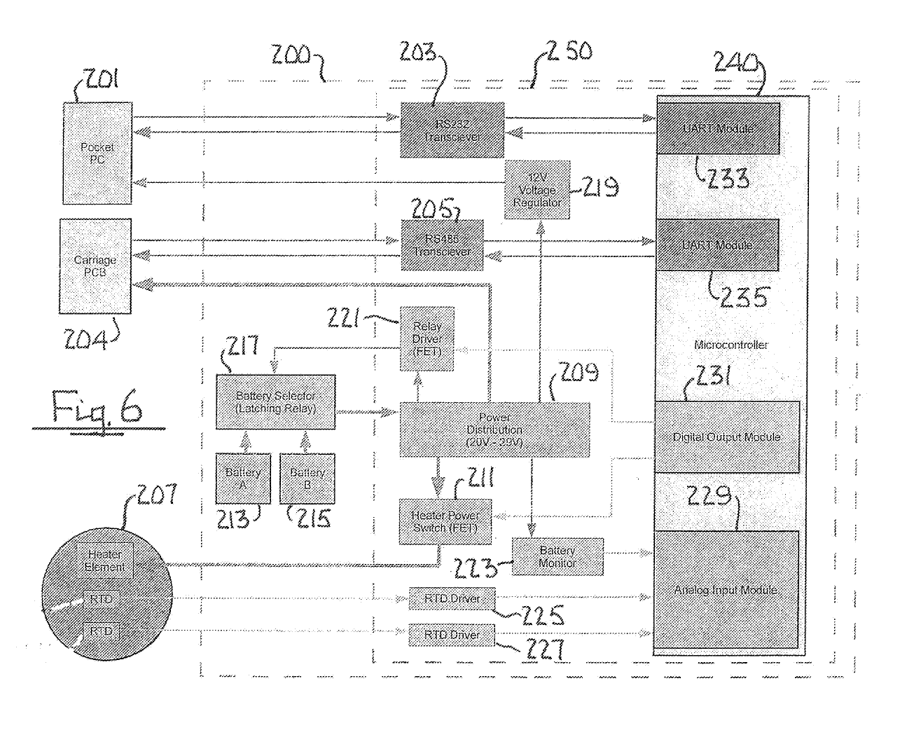

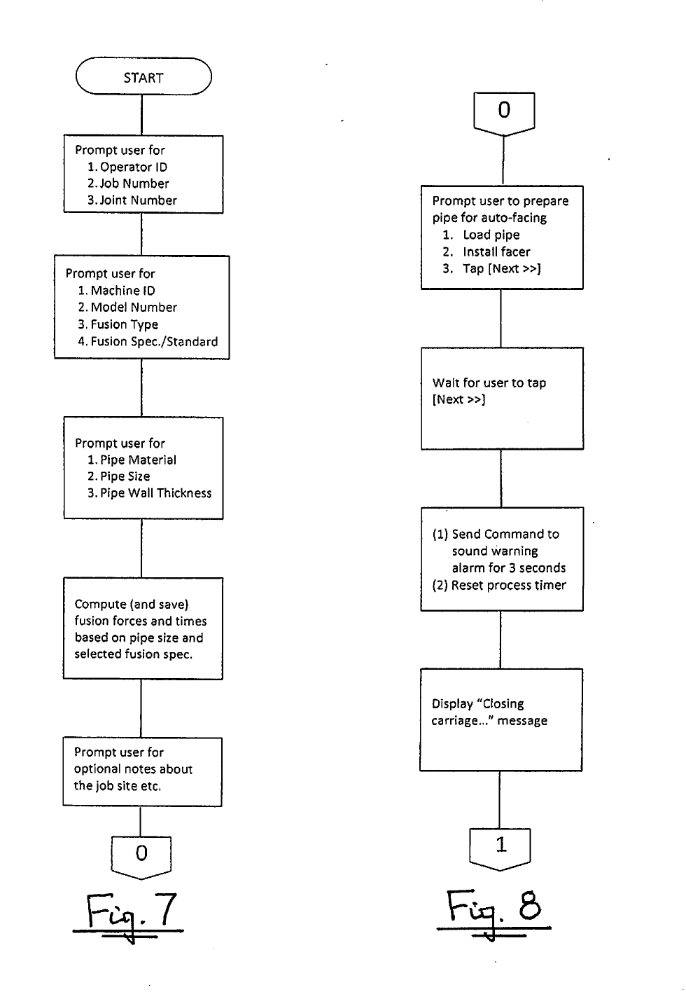

Looking at the command module block diagram of FIG. 6, a pocket PC 201 is in two-way a communication with a transceiver 203 and a carriage PCB 204 is in two-way communication with another transceiver 205. The heater element 207 is powered through the power distribution module 209 via the heater power switch 211. The power distribution module 209 receives electrical power from a pair of batteries 213 and 215 via a battery selector latching relay 217. The power distribution module also distributes power to a 12V regulator 219 serving the pocket PC 201, to a relay driver 221 with an output controlling the battery selector latching relay 217 and a battery monitor 223. Heater element data is communicated by RTD drivers 225 and 227 and battery data communicated by the battery monitor 223 to an analog input module 229. The relay driver 221 and the heater power switch 211 are controlled by the outputs of a digital output module 231. The transceivers 203 and 205 are in two-way communication with universal asynchronous receivers/transmitters 233 and 235. The UART modules 233 and 235, the digital output module 231 and the analog input module to 229 are part of the control module microcontroller 240. The microcontroller 240, the transceivers 203 and 205, the power distribution module 209, the heater power switch 211, the relay driver 221, the RTD drivers 225 and 227, the 12V regulator 219 and the battery monitor 223 are on the control module circuit board 250. The microcontroller 240, the circuit board 250, the batteries 213 and 215 and the battery selector latching relay 217 are in the command module 200.

### Operation of the System

The controls of the machine include an electrical closed loop circuit that controls operation of the screw drives 59 to transfer the travelling lower jaw 35 to a base axial distance from the fixed lower jaw 25 for performance of a fusion process task. The controls also include an electrical load cell feedback circuit that controls operation of the screw drives 59 to reciprocate the travelling lower jaw 35 in relation to the base axial distance in response to feedback from the load cells 49 so as to maintain a predetermined force between the pipeline and pipe stick during performance of the fusion process task.

Considering FIGS. 5, 6 and 15, the command module 200 rests in a cradle on the power base 100, is powered by the charging cable from the power base 100 and communicates via serial cable to the power base circuit 150 board. It provides a graphical interface for the operator. It calculates the appropriate time and force values based on information provided by the operator. It executes the fusion procedure by requesting actions in the feedback over a serial communication interface.

The requests from the command module 200 travel over a serial link of the transceiver 203 to the microcontroller 240 in the power base circuit board 250. Firmware running on the power base circuit board 250 interprets messages from the command module 200. Any requests for carriage action are forwarded over a serial link of the transceiver 205 to the microcontroller 140 in the carriage 10.

The carriage 10 responds to messages with an acknowledgment message that contains sensor and status data. The power base 100 gathers this information from the carriage 10, combines it with heater and battery feedback data and sends it all back to the command module 200 over the link of the transceiver 205.

Requests for battery switching, alarm activation or heater temperature target adjustment are acted upon by the power base control firmware and are not forwarded to the carriage 10. The digital output module 231 is used to activate the alarm and to switch between the two batteries 213 and 215 so that operation can continue when one battery to 213 or 215 is drained.

The power base circuit board 250 regulates heater temperature by monitoring the resistance of the RTDs in the heater 207. The resistance is measured by driving a constant electrical current through the RTDs and measuring the resultant voltage. Voltage from each RTD is channeled into an input pin on the analog input module 229 of power base circuit board microcontroller 240. A feedback loop in the software compares the heater feedback temperature to the target temperature set by the command module 200 and uses the digital output module 231 to drive the solid state switch 211 that controls the power flow to the heater 207. By adjusting the duration and frequency of power flow to the heater 207, the power base feedback loop maintains that target temperature set by the command module 200.

The firmware in the carriage microcontroller 140 implements two feedback loops that use at the dc motor 79 as an output. These feedback loops respond to requests from the command module 200. Requests from the command module 200 are relayed through the power base circuit board 250 and arrive over the communication bus of the transceiver 113. The transceiver 113 converts the differential transceiver signals to single-ended signals that can be read by the UART module 137 of the carriage microcontroller 140. The UART module 137 decodes the messages and firmware in the microcontroller 140 interprets the messages.

The dc motor 79 is the prime mover for the carriage 10. The carriage microcontroller 140 controls the direction of rotation and amount of applied torque by manipulating the inputs of the H-bridge module 121 that drives the motor 79. Two wires from the digital input module 127 set the direction of rotation and two wires from the pulse width modulation module 135 set the average applied voltage which controls top speed and torque.

Rotation of the motor shaft translates through a set of gears and screws and the results in linear movement of the pipe clamps. This linear motion is necessary for positioning the pipe and is for insertion and removal of leader and facer. Due to the plastic nature of the pipe material, small adjustments in linear motion can't be used to control the oppressive force applied to the pipe and other objects held in compression between the moving and fixed jaws 35 and 37 and 25 and 27.

The load cells 49 in the fixed jaws 27 provide feedback about the intensity of the applied force. These load cells 49 have a Whetstone bridge output that is fed into the load cell conditioners 131 that amplify the differential voltage from the load cells 49 and past the resultant voltage to the microcontroller analog input module 133. A force feedback loop runs in the software. This loop monitors the so feedback values from the load cells 49 and watches for force-related commands from the microcontroller 140. When activated by the microcontroller 140, this loop will make small discrete adjustments of the motor in order to affect very small linear movements of the travelling jaws 35 and 37. Do to the plasticity of the pipe, the small changes in position can be used for precise control of the inter-facial force between two pieces of pipe.

The incremental quadrature-type rotary encoder 125 in the rear train provides relative position feedback that is used to carry out position-related commands for opening and closing the distance between the jaws 25 and 35 of the carriage 10 by a fixed distance. This feedback is used during the critical bead-up phase of the fusion process. During bead-up this sensor precisely monitors the amount of plastic displaced against the heater 207 for a bead of molten plastic.

### User Interface Software Flow Chart

Turning to FIGS. 7-13, the inter-action of the user with the machine can be understood.

In FIG. 7, at the start of operation the user is prompted to enter task information such as the operator ID, the job number and the joint number. The user is next prompted to enter machine information such as the machine ID, the model number, the fusion type and the applicable fusion specifications and standards. The user is then prompted to enter pipe information such as pipe material, pipe size and pipe wall thickness. The machine microcontrollers then compute and save fusion forces and times based on pipe size and the applicable fusion specifications and standards. The user is then prompted to enter optional notes about the job site and other notable information relative to the application.

In FIG. 8, after the necessary information has been entered and calculated, the user is prompted to prepare the pipe for auto-facing, including loading the pipeline and pipe stick into the jaws and installing the facer between them. When the user indicates completion of these tasks by tapping “next,” the machine sends a command to sound a warning alarm and resets the process timer. The machine then displays the message “Closing carriage . . . ”.

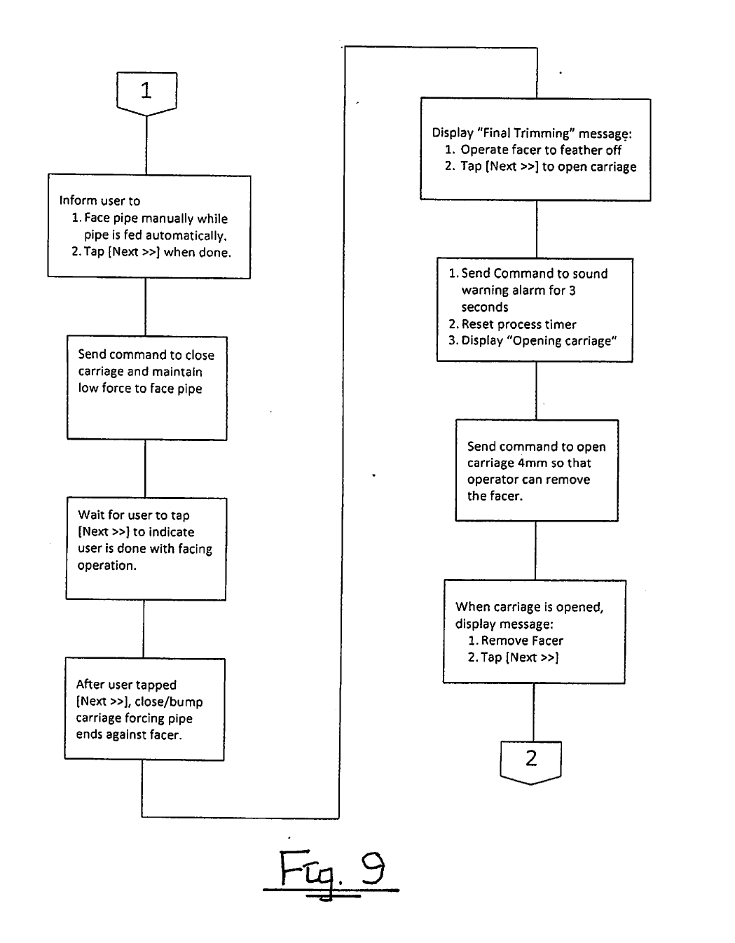

In FIG. 9, after the message display, the user is told to face the pipe manually while the pipe is fed automatically by the machine. When the user indicates completion of these tasks by tapping “next,” the machine sends a command to close the carriage and maintain low force to face the pipe. The machine then waits for the user to signal that the facing operation is completed. After the machine receives the signal, the machine closes/bumps the carriage, forcing the pipe ends against the facer. In this position, the machine displays the “final trimming” message and operates the facer to feather off the pipes. When the user signals that feathering is completed, The machine sends commands to sound the warning alarm, reset the process timer and display “opening carriage.” The machine then sends a command to open the carriage so that the operator can remove the facer. Once the carriage is opened, the machine displays the message “remove facer.” After removing the facer, the user signals the machine that the task is completed.

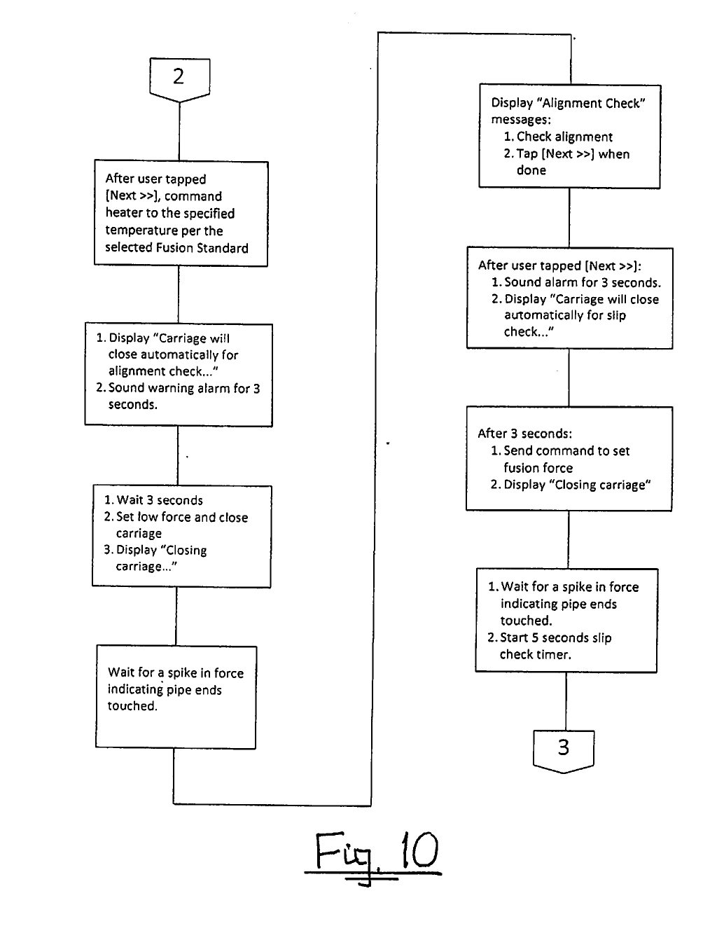

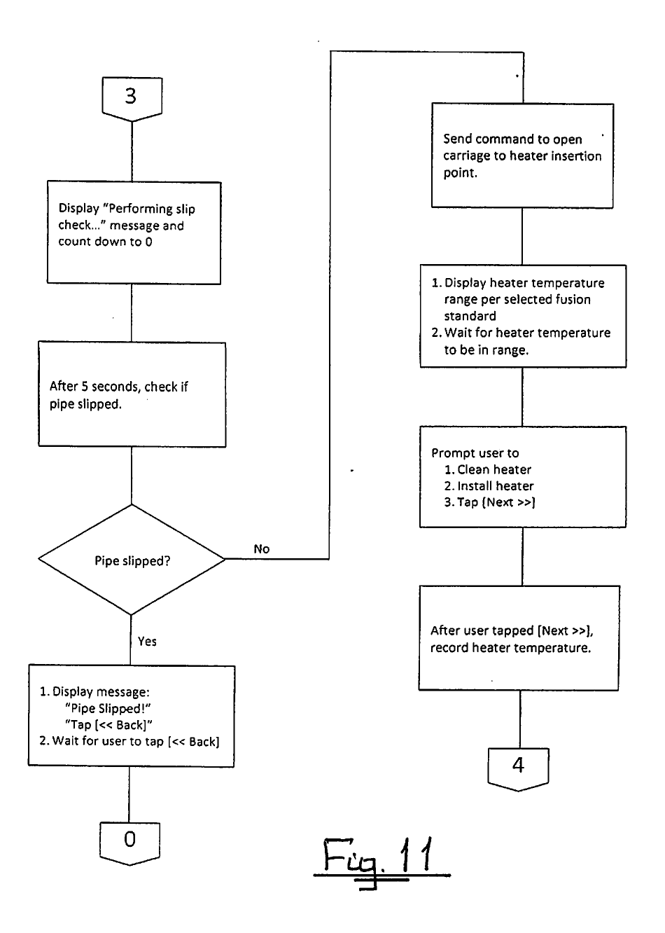

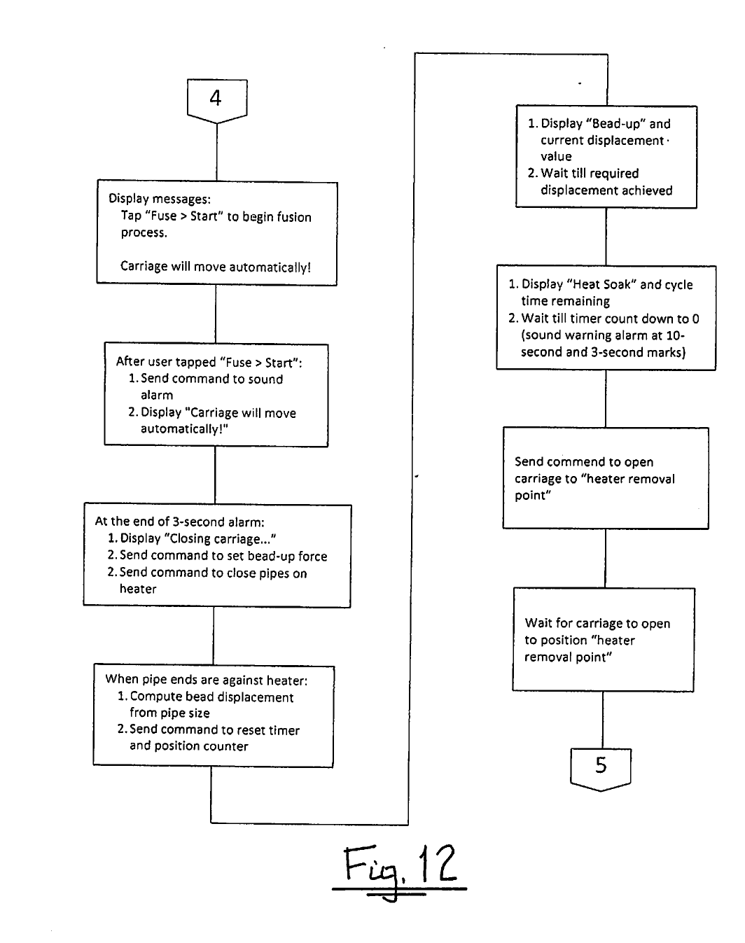

In FIG. 10, after the machine commands the heater to the specified temperature per the selected fusion standard. The machine then displays “carriage will close automatically for alignment check . . . ” and soundness warning alarm. The machine and then sets a low force, closes the carriage and displays “closing carriage . . . ”. The machine then waits for a spike in force indicating that the pipe bands have touched. The machine then displays the “alignment check” message. Once the alignment is checked, the user signals completion to the machine. The machine then sounds the alarm and displays “carriage will close automatically.” The machine sends a command to set the fusion force and displays “closing carriage” and waits for a spike in force indicating the pipe ends touched and starts the slip check timer.

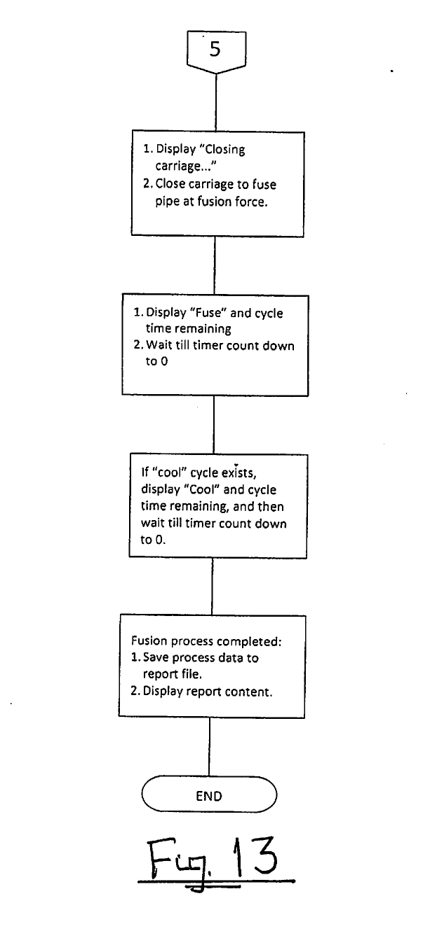

In FIG. 11, the machine displays the “performing slip check . . . ” message and begins counting down to zero. When the time lapsed machine checks to see if the pipe has slipped. If so, the machine displays the message “Pipe slipped!” and waits for the user to confirm receipt of the message, after which the machine returns to the “0” position of FIG. 8. If the pipe has not slipped, the machine sends the command to open the carriage to the heater insertion point. The machine then displays the heater temperature range per the selected fusion standard and waits for the heater temperature to be in range. The machine then prompts the user to clean the heater, install the heater and signal when the tasks are completed. When the machine receives the signal, it records the heater temperature.

In FIG. 12, the machine displays the messages “tap ‘Fuse>Start’ to begin fusion process” and “Carriage will move automatically!” When the user has tapped “Fuse>Start” the machine and send a command to sound the alarm and displays “Carriage will move automatically!” At the end of the alarm, the machine displays “closing carriage . . . ” and sends commands to set bead-up force and to close pipes on the heater. When the pipe ends are against the heater the machine computes the bead displacement from the pipe size and sends commands to reset the timer and position the counter. The machine then displays “bead-up” and the current placement value and waits until the required displacement is achieved. The machine then displays “heat soak” and the cycle time remaining and waits until the timer count down to zero, sounding the warning alarm twice during the countdown. The machine then sends the command to open the carriage to the “heater removal point” and waits for the carriage to open to that position.

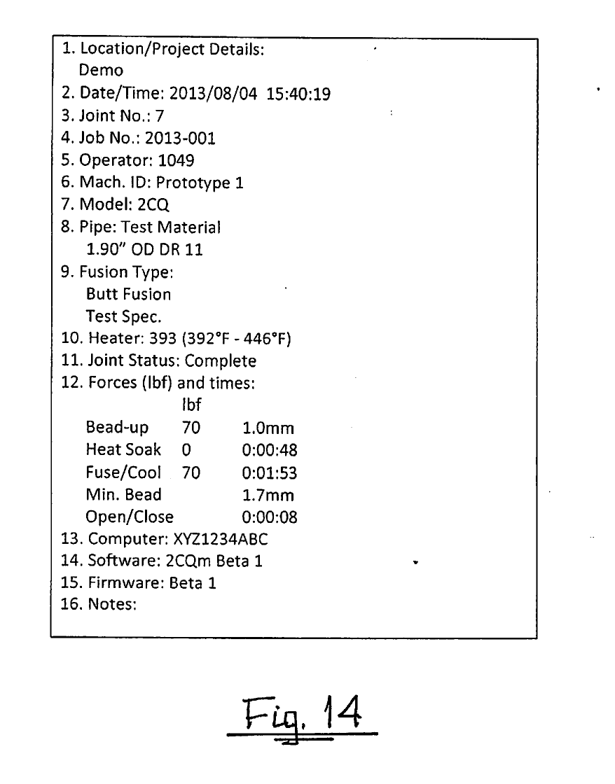

In FIG. 13, the machine displays “closing carriage” and closes the carriage to fuse the pipe at fusion force. When machine displays “Fuse” and cycle time remaining as the timer counts down to zero. This completes the fusion process and the machine saves the process data to report file and displays the report content. Turning to FIG. 14, a sample report is illustrated.

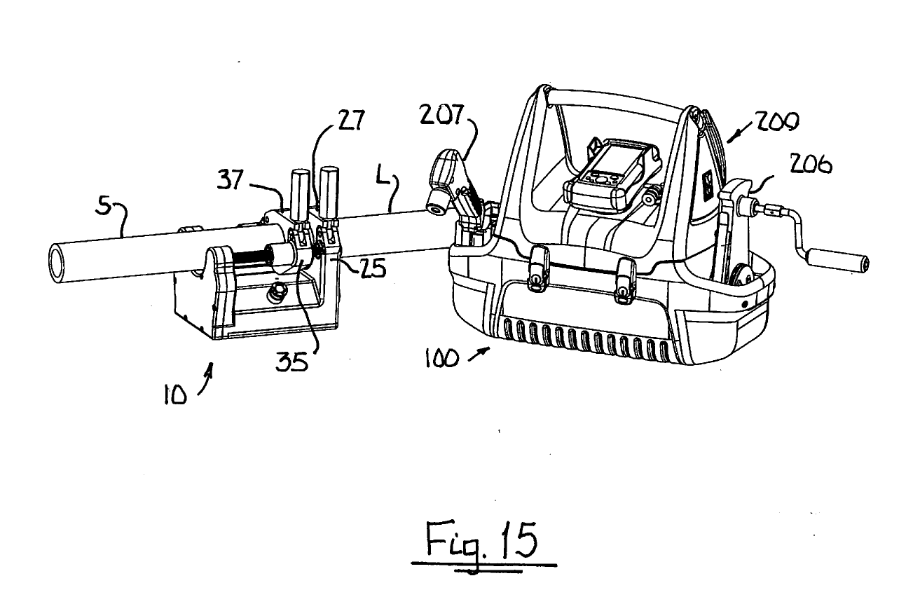

As seen in FIG. 15, the machine, including the carriage 10 and the power base 100 carrying the command module 200, the facer 206 and the heater 207, is illustrated with a pipeline L and a pipe stick S gripped in the fixed jaws 25 and 27 and the travelling jaws 35 and 37 and the carriage in its closed condition.

Thus, it is apparent that there has been provided, in accordance with the invention, an electro-mechanical pipe fusion machine that fully satisfies the objects, aims and advantages set forth above. While the invention has been described in conjunction with a specific embodiment thereof, it is evident that many alternatives, modifications and variations will be apparent to those skilled in the art and in light of the foregoing description. Accordingly, it is intended to embrace all such alternatives, modifications and variations as fall within the spirit of the appended claims.

What is claimed is:

1. A machine for fusing polyolefin pipe comprising a carriage comprising:
a base;
two screws journaled for rotation on said base in spaced-apart parallel horizontal alignment;
a first lower jaw on said base between said screw;
a first upper jaw pivotally mounted on said first lower jaw and co-operable with said first lower jaw to grip a first pipe therebetween in axial alignment with said screws;
a second lower jaw mounted for reciprocal travel on said screws; and
a second upper jaw pivotally mounted on said second lower jaw and co-operable with said second lower jaw to grip a pipe therebetween in axial alignment with the first pipe;
said screws being electrically driven to selectively reciprocate said second lower jaw toward and away from said first lower jaw to bring gripped pipes into and out of close proximity, respectively, for performance of fusion process tasks.

2. A machine according to claim 1 further comprising controls comprising:
an electrical closed loop circuit controlling operation of said screws to transfer said second lower jaw to a base axial distance from said first lower jaw for performance of a fusion process task; and
an electrical load cell feedback circuit controlling operation of said screws to reciprocate said second lower jaw in relation to said base axial distance in response to feedback from said load cells to maintain a predetermined force between the pipes during performance of the fusion process task.
